(19) United States
(12) Patent Application Publication
(10) Pub. No.: US 2015/0056513 A1
(43) Pub. Date: Feb. 26, 2015

(54) POWDER COMPRISING CARBON NANOSTRUCTURES AND ITS METHOD OF PRODUCTION

(71) Applicant: CAMBRIDGE ENTERPRISE LIMITED, Cambridge (GB)

(72) Inventors: Derek John Fray, Cambridge (GB); Carsten Schwandt, Cambridge (GB); Rajshekar Dasgupta, Toronto (CA); Ali Kamali, Cambridge (GB)

(21) Appl. No.: 14/388,710

(22) PCT Filed: Mar. 15, 2013
(86) PCT No.: PCT/GB2013/050672

§ 371 Date: Sep. 26, 2014

(30) Foreign Application Priority Data
Mar. 26, 2012 (GB) 1205290.8

(51) Int. Cl. H01M 4/587; H01M 4/04; H01M 4/1393; C25B 1/14; H01M 4/133

(52) U.S. Cl. CPC H01M 4/587; C25B 1/14; H01M 4/133; H01M 4/1393; H01M 4/0459; H01M 2004/027
USPC 429/231.4; 205/59

(57) ABSTRACT

A powder comprises a plurality of carbon nanostructures, with at least a portion of the carbon nanostructures defining an internal cavity that contains metallic lithium, a lithium compound, or a lithium alloy comprising lithium. A method of forming the powder involves the electrolytic disintegration of a graphite electrode in a lithium-bearing molten salt to form the carbon nanostructures, and a step of removing salt from the nanoparticles without removing lithium. A lithium battery anode comprising an anode comprising the powder as a layer on an electrically conductive substrate.

The invention relates to a powder comprising carbon nanostructures containing lithium, lithium compounds, or lithium alloys, for example carbon nanostructures containing lithium intermetallic compounds, and a method for the production of such materials. The invention also relates to anodes comprising such carbon nanostructures or powders.

Rechargeable electric cells in which current is carried by Li ions are well known, and are generally termed Li-ion cells. Various types of these cells are available, such as Li-ion polymer cells. In Li-ion cells, two electrodes termed a cathode and an anode are separated by a Li-ion-conducting electrolyte. Both the cathode and the anode comprise materials into which Li can be removably inserted, and the electrolyte is a material through which Li ions can migrate. When a cell is charged, Li has been transported to, and is stored in, the anode. When the cell discharges, Li ions migrate through the electrolyte from the anode to the cathode.

In a conventional Li-ion cell or battery, the cathode may be LiₓCoO₂(0.5<=x<=1), LiFePO₄ or some other host compound material in which there is a strong interaction between lithium and the host compound, and in which the lithium is highly mobile.

The anode of most conventional Li-ion cells comprises graphite. Li can be removably inserted into the crystal structure of graphite by a process of intercalation, for example to form an intercalation compound of lithium in graphite, Li_{0.167}C, with a typical capacity of 372 mAh/g. The graphite is usually provided in powder form, coated on a surface of a conductive anode substrate (e.g. a Cu sheet) by means of a binder. However, repeated charge and discharge cycles require repeated insertion of Li into the graphite and removal of the Li from the graphite, which ultimately damages the graphite and reduces the charging capacity of the cell.

Various alternative anode materials have been proposed to improve the performance of Li-ion cells, with the aim of increasing the amount of Li which can be inserted into the anode, decreasing the damage done to the anode by repeated charging and discharging, and decreasing the energy required to insert and remove Li into and from the anode. Most success has been achieved with Sn and Si, which both form alloys with Li. However, the insertion and de-insertion of substantial quantities of lithium into these materials is associated with very large volume changes. Therefore, if an anode comprises particles of Si or Sn supported on an anode substrate, the particles are subject to continual volume changes during charging and discharging which leads to the anode material decrepitating and particles losing electrical contact with each other or with the substrate. As a result, the capacity of the anode gradually diminishes and the performance of the battery decreases after a few tens of charge-discharge cycles.

One prior art approach to improve anode design has involved the use of elongate nanowire structures. A recent example was published by Chan et al in Nature Nanotechnology, 12 Dec. 2007, in a paper entitled “High-performance lithium battery anodes using silicon nanowires”. This describes an anode comprising a “forest” of Si nanowires of approximately 10 nm diameter. The Si nanowires expand up to four times in diameter as they are loaded with Li during discharge of a rechargeable cell. A second example was published by Zhou et al in “Si/TiSi₂ Heteronanostructures as High-Capacity Anode Material for Li-Ion Batteries”, Nano Letters, 2010 (January). This describes a TiSi₂ lattice structure comprising TiSi₂ nanowires of approximately 100 nm diameter, coated with Si, which can absorb Li. A third example is U.S. Pat. No. 7,402,829, which describes a method for etching a Si surface to form an array of elongate Si pillars of sub-micrometre diameter.

In all of these cases, an aim of the elongate nanostructures is to allow absorption of Li with reduced damage to the anode material due to volume changes, while retaining good electrical conductivity along and between the elongate structures. For example, the small lateral dimensions of the Si nanowires or pillars may allow large volume changes with less damage to the Si than would occur in larger Si structures.

It is an object of the invention to improve on the performance of these prior art anode structures.

### STATEMENT OF INVENTION

The invention provides powders, anodes, Li-ion cells and methods as defined in the appended independent claims, to which reference should now be made. Preferred and advantageous features of the invention are set out in various dependent sub-claims.

In a first aspect the invention may provide a powder comprising a plurality of carbon nanostructures, at least a portion of the carbon nanostructures defining an internal cavity containing metallic lithium, a lithium compound, or an alloy between lithium and at least one other metal or metalloid. Lithium compounds are preferably lithium oxides or oxides that comprise lithium and other elements.

In the prior art, metal-filled carbon nanotubes have been fabricated by various techniques, involving the fabrication of empty nanotubes and then filling the nanotubes with metal. Such techniques generally involve removing or opening the closed end of an empty, hollow nanotube for filling. In the prior art, there are descriptions of carbon nanoparticles but these are generally solid structures, and not hollow.

The term carbon nanostructures may include various carbon elements having a nanometre scale. The term as used herein includes nanotubes, nanofibres, and nanoparticles.

The term carbon nanotube refers to a carbon element having a substantially cylindrical tubular nanostructure. The term includes single-walled nanotubes and multi-walled nanotubes. As used herein, the term may also include nanoscrolls, i.e. nanotubes formed from a rolled graphene sheet. The term may also encompass graphene nanofibres and carbon nanofibres. Carbon nanotubes typically have a diameter ranging from 1 nanometre to about 100 nanometres. The length to diameter ratio is greater than 5:1 and the length may even be more than a million times the diameter.

The term nanoparticle refers to a carbon element having nanoscale external dimensions and an aspect ratio of less than 5:1. Typically a nanoparticle will have an aspect is ratio of close to 1:1. A nanoparticle may be hollow and may contain another substance or material, such as a metal, metalloid, alloy or compound. Compounds may include oxides. A nanoparticle may comprise a portion of a graphene sheet wrapped around a nanoscale metallic particle. Typically a nanoparticle has a maximum dimension of between 1 nanometre and 20 nanometres, typically between about 2 and 10 nanometres, or between 3 and 6 nanometres.

Lithium reversibly alloys with a number of metals according to the following reversible reaction:

XM+YLi⁺+Ye [symbol] M_{X}Li_{Y}

where M is a metal or metalloid such as tin (Sn) or silicon (Si).

M_{X}Li_{Y} is often a lithium-metal intermetallic. As used herein, the term alloy includes an intermetallic. Thus, a Li₂₂Si₅ intermetallic composition is considered to be an alloy for the purposes of the disclosure herein.

In the reversible reaction noted above, the lithium alloy, M_{X}Li_{Y}, may be more than three times the volume of the metal or metalloid, XM. As the powder of the first aspect of the invention comprises carbon nanostructures that contain the phase with the higher volume, an anode formed comprising the powder should not increase in volume during use. Furthermore, a cell formed using the powder as an anode component will contain much of, or all of, the lithium required for the cell to operate, and will be in a pre-charged, or partially pre-charged, condition.

When a cell comprising the powder is discharged, lithium ions are transported from the anode to the cathode. This results in a loss of volume of the lithium alloy phase as the lithium is transported away. Thus, the volume of metal contained within the nanostructures is reduced. When the cell is re-charged, however, lithium is transported back to the anode where lithium alloys reform. The accompanying expansion in volume may be accommodated because the nanostructure originally formed around the greater of the volume conditions of the contained metal.

Preferably, carbon nanoparticles contain the majority of the metallic lithium, or the alloy of lithium and at least one other metal. Preferably the volume of metal contained within each nanoparticle ranges from between 1 cubic nanometre to about 10000 cubic nanometres, preferably less than 5000 cubic nanometres, preferably less than 1000 cubic nanometres. By maximising the surface area to volume ratio, the transfer of lithium ions may be optimised. My reducing the total volume of metal within the nanoparticle, the effects of repeated volume expansions and contractions may be minimised.

Any fabrication technique is likely to fabricate nanoparticles having a range of sizes, and so in a preferred embodiment of the invention at least 50%, preferably more than 70% and particularly preferably more than 85%, of the carbon nanoparticles have a maximum dimension, or diameter, of less than 25 nm, preferably less than 15 nm, and particularly preferably less than 10 nm.

The powder may comprise nanotubes. Nanotubes may be the sole container for the lithium, lithium compound, or lithium alloy. However, it is preferred that the primary container for lithium or lithium alloy is a nanoparticle component of the powder. There may be an advantage in the powder comprising both nanoparticles and other nanostructures such as nanotubes. While nanoparticles may be the preferred container for lithium or lithium alloys, the presence of nanotubes in the powder may help to maintain electrical contact over repeated charge/discharge cycles of any anodes comprising the powder. Nanotubes and nanofibres may have high length to diameter ratios that enable them to electrically contact a large number of separate nanoparticles.

It may be advantageous to control the ratio of nanoparticles to nanotubes within the powder. The ratio of number of carbon nanoparticles to number of other carbon nanostructures is preferably greater than 1:1, preferably greater than 2:1, or 3:1, or 4:1. The number ratio may be greater than 10:1, or 20:1. Processing parameters may be varied to achieve a desired ratio. The powder may comprise a mixture of both nanostructures formed containing lithium or a lithium alloy, and nanostructures formed without any lithium or lithium alloys. Lithium-free nanostructures may be included to improve the electrical and/or structural properties of the powder and any anode formed comprising the powder.

Preferably, the powder comprises nanostructures formed by the electrolysis of a carbon cathode in a molten salt. Processes for the production of carbon nanotubes by this route are known in the art. Advantageously, the nanostructures formed by molten salt electrolysis may simply be rolled or wrapped graphene sheets rather than more perfect tubular structures that can be formed by other processes. For example, it is understood that, during molten salt processing, nanostructures such as nanotubes are formed by the folding of portions of graphene sheets that are ejected from a carbon cathode. These sheets fold to form tubes or particles, and may encompass metallic particles present at or near the cathode. Because the process does not involve a catalyst, it may be that a large proportion of the graphene sheets do not cleanly join to form a perfectly enclosed volume such as a sphere or a tube. A graphene sheet may, for example, roll up to form a tube-like structure commonly referred to as a nanoscroll, due to its similarity to a scroll of paper. Advantageously, nanoparticles formed by molten salt processes may contain a metal or alloy without ever completely encapsulating the metal or alloy. In a Li-ion cell, lithium ions need to be transported between an anode and a cathode. If a lithium alloy is contained by a nanoscroll type structure, or a crumpled graphene sheet, the lithium ions can move into and out of the structure more freely than if the lithium alloy was completely encapsulated within a perfect nanotube and the lithium ions were required to transport through the graphene wall of the nanotube.

Preferably, each of the carbon nanostructures that defines an internal cavity containing the metallic lithium, or an alloy of lithium, comprises one or more graphene sheets wrapped around a portion of the metal or alloy.

Metallic lithium is a highly reactive element. Lithium metal may be a dangerous component of a powder, or an anode comprising the powder. However, by containing small volumes of metallic lithium within carbon nanostructures the dangers may be somewhat ameliorated.

Preferably, the lithium species in the powder is in the form of a lithium alloy, such as an intermetallic. Preferably the lithium alloy comprises one or more elements selected from the list comprising silicon, tin, zinc, strontium, lead, antimony, aluminium, astatine, and germanium. The lithium species in the powder may be in the form of an alloy or compound. Any material that forms an alloy or compound with lithium may be used. Preferably the lithium alloy or compound comprises one or more elements selected from the list consisting of Ag, Al, As, Au, Ba, Bi, Ca, Cd, Cu, Ga, Ge, Hg, In, K, Mg, Na, Pb, Pd, Pt, S, Sb, Si, Sn, Sr, Ti and Zn.

It is particularly preferred that the powder is used as a component part of an anode for a lithium-ion cell. The powder may be mixed with a suitable polymer binder for bonding to an electrically-conducting substrate. Alternatively, the powder may have appropriate properties to be coupled to an anode without binder. The powder may be agglomerated or consolidated prior to being used to form an anode.

A second aspect may provide a method of making a powder according to the first aspect.

Thus, a method of forming a powder comprising a plurality of carbon nanostructures, at least a portion of the carbon nanostructures defining an internal cavity containing metallic lithium, may comprise the steps of, arranging a graphite electrode in contact with a molten salt in an electrolysis cell, the molten salt comprising lithium, applying a cathodic potential to the graphite electrode such that metallic lithium deposits at the graphite electrode and the graphite electrode disintegrates into a plurality of carbon nanostructures containing lithium, collecting the nanostructures, and removing salt from the nanostructures without removing lithium. This method would produce a powder comprising lithium metal contained within carbon nanostructures.

A method of forming a powder comprising a plurality of carbon nanostructures, at least a portion of the carbon nanostructures defining an internal cavity containing an alloy of lithium and at least one other metal or metalloid, may comprise the steps of, arranging a graphite electrode in contact with a molten salt in an electrolysis cell, the molten salt comprising a lithium salt and a salt of the at least one other metal or metalloid, applying a cathodic potential to the graphite electrode such that the at least one other metal or metalloid deposits at the graphite electrode and lithium reacts with the graphite electrode such that it disintegrates into a plurality of carbon nanostructures containing an alloy of lithium and at least one other metal or metalloid, collecting the nanostructures, and removing salt from the nanostructures without removing lithium. This method would produce a powder comprising a lithium alloy contained within carbon nanostructures.

It is understood that, when a voltage is applied, lithium ions are intercalated into the graphite electrode. This causes graphene sheets to be forced out of the electrode structure. The cell may be operated such that lithium metal droplets also form at the electrode, which is cathodically biased. The graphene sheets may then wrap or roll around these droplets to form particles or tubes. If no other metallic species is present, the result is a lithium cored carbon nanostructure.

Where lithium alloys are to be formed, it is understood that the additional metal component of the salt also deposits at the electrode to be incorporated within a carbon nanostructure.

The inventors have investigated the formation of anode materials, such as powders, comprising metal-filled or metal-cored carbon nanostructures. Many of the elements listed above as preferred lithium alloying elements are solid at the temperature of the electrolysis process and it is, therefore, difficult to see how these solids could be incorporated within and fill carbon nanotubes and nanoparticles completely. However, all of these elements form low melting alloys with lithium, so that although the elements may initially be solid when first deposited on the graphite electrode, the subsequent deposition of the lithium may cause liquid lithium-metal alloys to form. There is no intercalation of the alloying metals or metalloids into the graphite, but when the lithium intercalates into the graphite the extruded graphite sheets are able to encapsulate the liquid alloys which, on solidification, form intermetallic compounds containing a significant amount of lithium.

Prior art methods for electrolytically producing nanostructures involve a step of washing salt from the nanostructures using water. The salts typically used, for example sodium chloride, are soluble in water. As water is readily available, water is the obvious choice for the skilled person preparing carbon nanostructures. However, water reacts strongly with lithium and lithium ions. Thus, washing in water prevents the production of carbon nanostructures containing lithium or lithium alloys, the step of washing the product in water is deleterious. Thus, the salt needs to be removed from the nanostructures without removing the lithium or lithium species from the powder.

A preferred method involves washing salt from the powder product of the method using a liquid that removes the salt, for example by dissolving the salt, but does not react with lithium. Preferred examples of such liquids are methanol, hydrazine, and ethylene carbonate, although the skilled person may be able to determine other liquids with similar properties. After washing, it is preferred that the powder is dried. This may be effected by heating in a protective atmosphere or a vacuum.

An alternative method of removing salt may involve heating the product under a protective atmosphere or in a vacuum in order to evaporate the salt. Although the metal or alloy contained within the nanostructures is likely to melt, the containment may prevent any significant evaporation of lithium.

As discussed above, the relative proportion of nanoparticles to nanotubes may be important, and this may be controlled during the processing. The inventors have found that the proportion of nanoparticles to nanotubes may be controlled by varying the temperature of the process and by varying the potential applied to the graphite electrode during the process.

In a lithium chloride based salt the production of nanoparticles may be preferred over the production of nanotubes if the temperature of the molten salt is increased above 700 degrees centigrade, preferably above 750 degrees, or above 800 degrees.

In a lithium chloride based salt the production of nanoparticles may be preferred over the production of nanotubes if the voltage applied to the graphite electrodes greater than −3 V, for example greater than −4 V, or −4.5V, or −5V, or −6V. As the potential is cathodic it may be expressed by negative voltage values. These values represent the potential between the graphite electrode and a further electrode that acts as an anode.

A further parameter that may influence the type of carbon nanostructures produced by the method is the average out-of-plane crystallite size of the graphite electrode. The out-of-plane crystallite size is a commonly quoted characteristic of graphite materials. This parameter, usually denoted may be determined by X-ray diffraction or Raman spectroscopy techniques.

A high out-of-plane crystallite size, for example greater than 20 nanometres, or greater than 25 nanometres, preferably greater than 30 or 35 nanometres, favours the production of carbon nanotubes rather than carbon nanoparticles. Conversely, a low out-of-plane crystallite size, for example lower than 20 nanometres, or lower than 15 nanometres, favours the production of carbon nanoparticles rather than carbon nanotubes. By selecting an appropriate graphite electrode material and appropriate processing parameters, it is possible to produce a carbon powder substantially consisting of carbon nanoparticles with substantially no carbon nanotube content.

It is preferred that the molten salt comprises lithium chloride. The salt may comprise other components such as lithium oxide.

Where it is intended to form a nanostructure containing a lithium alloy, it is preferred that the molten salt is lithium chloride based, with a further salt or salts comprising the alloying element. It is preferable that the salt of the one or more alloying element is also a chloride.

Some elements have volatile chlorides that may be unstable at the desired processing temperatures. An example is silicon chloride. In order to produce a nanostructure containing a lithium-silicon alloy it is preferred that the molten salt comprises a silicon fluoride, preferably potassium hexafluorosilicate.

A user may wish to modify the powder that is directly obtained from the process described above. Thus, there may be a further step of adding further nanostructures, for example conductive nanostructures to improve the overall electrical conductivity of the powder. It may be advantageous to add a portion of nanofibres or nanotubes, for example nanofibres or nanotubes produced by a different process. In addition to modifying flow properties, such additional particles may also modify flow properties and agglomeration properties of the powder. Preferably the further nanostructures comprise no more than 50% or 60% of the powder, preferably less than 40% for example less than 20% or 10%.

In a third aspect, a method of forming a powder comprising a plurality of carbon nanostructures, at least a portion of the carbon nanostructures defining an internal cavity containing an alloy comprising lithium and silicon, may comprise the steps of, arranging a graphite electrode in contact with a molten salt in an electrolysis cell, the molten salt comprising a lithium salt and a non-chloride silicon salt, applying a cathodic potential to the graphite electrode such that silicon deposits at the graphite electrode and lithium reacts with the graphite electrode such that it disintegrates into a plurality of carbon nanostructures containing an alloy comprising lithium and silicon, collecting the nanostructures, and washing salt from the nanostructures.

It is preferred that the non-chloride silicon salt is a silicon fluoride salt, for example a hexafluorosilicate salt, preferably potassium hexafluorosilicate.

In a fourth aspect, an anode for a Li-ion rechargeable cell may comprise any powder described above or any powder formed by a method described above.

An anode embodying this aspect of the invention advantageously comprises nanostructures containing lithium or a lithium alloy, for example intermetallic-cored carbon nanotubes and/or nanoparticles. The anode is not necessarily fabricated exclusively from these materials. For example, the performance of an anode may be improved by the presence of at least a proportion of nanoparticles in the anode material. In one embodiment, therefore, an anode material may comprise a mixture of materials comprising metal intermetallic cored carbon nanotubes and nanoparticles as well as other materials, such as non-carbon nanotubes. Preferably, however, at least 50%, preferably at least 70% and particularly preferably at least 85% of the mixture of materials at the anode comprises intermetallic-cored carbon nanotubes and nanoparticles.

When used as an anode in a lithium ion battery, lithium from the lithium alloys can transport through the walls of the nanotube or nanoparticle, ionise and diffuse to the cathode. As the lithium is removed from the intermetallic compound the metallic core shrinks in volume but still remains in electrical contact with the highly electrically conducting carbon nanotube or nanoparticle. When the anode is recharged, the intermetallic compound reforms also remaining in contact with electrically carbon nanotube or nanoparticle. The considerable advantage of this approach is that the required amount of lithium is incorporated into the anode, prior to incorporation into the battery and secondly there is no volume change of the anode during the charging/discharging process.

The inventors' observation that lithium is capable of diffusing through the containing wall of a carbon nanostructure, due to the small size of the Li ion, while any alloying material such as tin, silicon or germanium remains contained, or trapped, within the nanostructure leads to the recognition that in order to optimise the performance of an anode comprising such products, it is desirable to maximise the ratio of surface area to volume of the carbon nanostructures comprised in the anode. In order to achieve this, it is desirable to use lithium or lithium alloy filled nanoparticles rather than the elongate nanotubes or the metallic nanowires described in the prior art. As described above, there is a trend in the prior art to use elongate materials, partly in order to ensure good electrical conductivity across and through the lithium insertion material at the anode. However, the present inventors have appreciated that it is preferable to use nanoparticulate anode materials having high ratios of surface area to volume and small lateral dimensions, or diameter. This may advantageously maximise the surface area through which lithium can diffuse into the insertion material at the anode, minimise the distance along which the lithium needs to diffuse into the insertion material, and maximise the mass of lithium which can be inserted at the anode due to the high packing density of nanoparticles which may be achieved. These advantages may advantageously enable faster charging and discharging of a lithium-ion cell, and increased electrical storage capacity, together with longer cell lifetime.

Lithium-containing nanostructures for fabricating anodes embodying the invention, such as the powders described above, may be fabricated in any suitable way. It is believed, however, that the most appropriate currently available technique is the molten-salt electrolysis technique described above.

In a fifth aspect the invention may provide a method of forming an anode. The method of forming an anode may comprise the steps of coupling a powder to an electrical conductor, the powder being any powder described above. In the method, the powder is optionally mixed with other materials and/or with a binder and/or with a plasticiser, and is preferably attached to a surface of an anode substrate, such as a conductive metal sheet.

Advantageously, the resulting anode material is a carbon-based particulate material, which can be handled in substantially the same way as known anode materials for lithium insertion. Thus, in some embodiments intermetallic cored nanostructures or nanomaterials may be mixed with a polymer binder for attachment to an anode support, where the anode is to be used in a cell with a liquid electrolyte. In other embodiments, intermetallic cored nanomaterials may be mixed with a suitable plasticiser and, if appropriate, a polymer binder, if the anode is for use with a solid polymer electrolyte. In either case, the mixture of nanomaterials and binder and/or plasticiser may be coated onto an anode support in the same way as for conventional anode materials, as the skilled person would appreciate. It may be advantageous to use as small a quantity of binder or plasticiser as possible, and if possible none, in order to maximise the density of nanoparticles which can be attached to the anode substrate, and thus to maximise the mass of lithium which can be inserted into the anode. If a binder or plasticiser is used, the mixture of particles and binder may be applied to the substrate surface and heated to remove at least a portion of the binder or plasticiser.

A sixth aspect may provide a lithium-ion cell comprising a lithium containing nanostructure as described above. For example, a Li-ion cell may comprise an anode incorporating a powder described above or manufactured using a method described above. A Li-ion cell may comprise any anode as described above.

Specific embodiments of the invention will now be described by way of example, with reference to the drawings, in which;

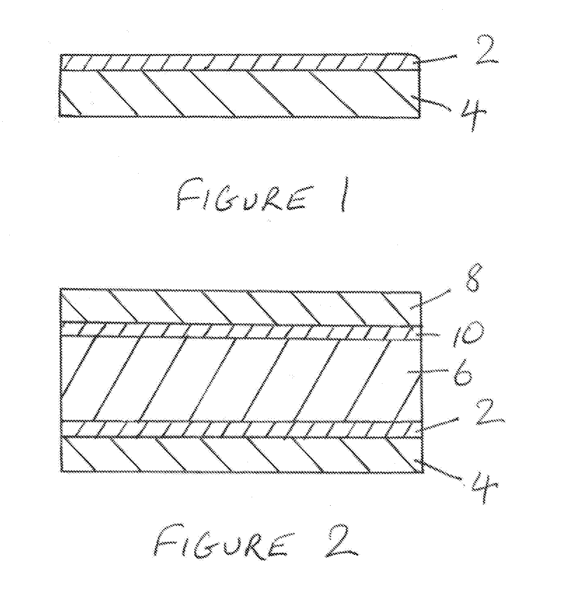

FIG. 1 is a schematic cross-section of an anode embodying an aspect of the invention;

FIG. 2 is a schematic cross-section of a rechargeable cell embodying an aspect of the invention;

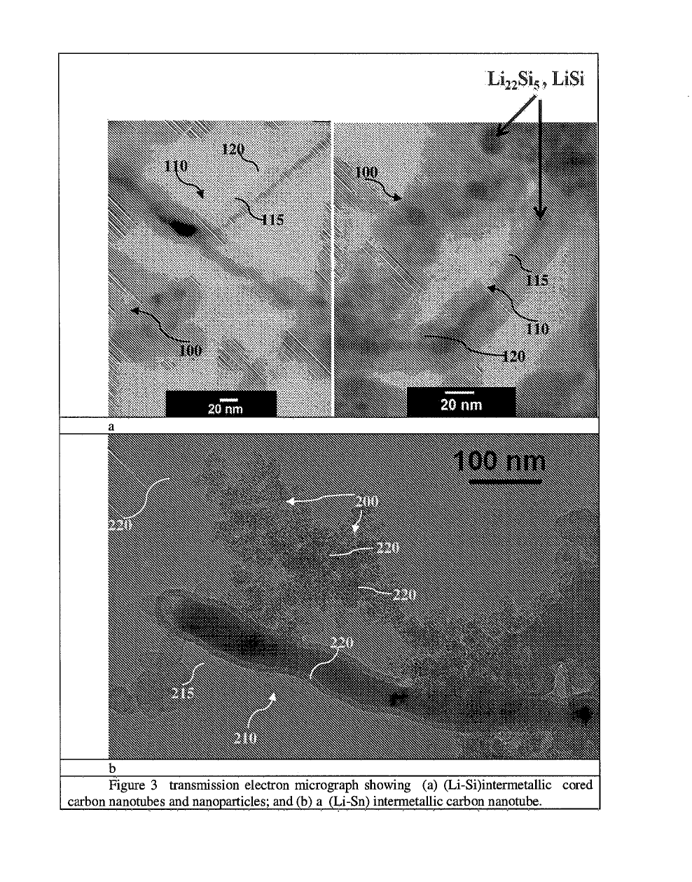

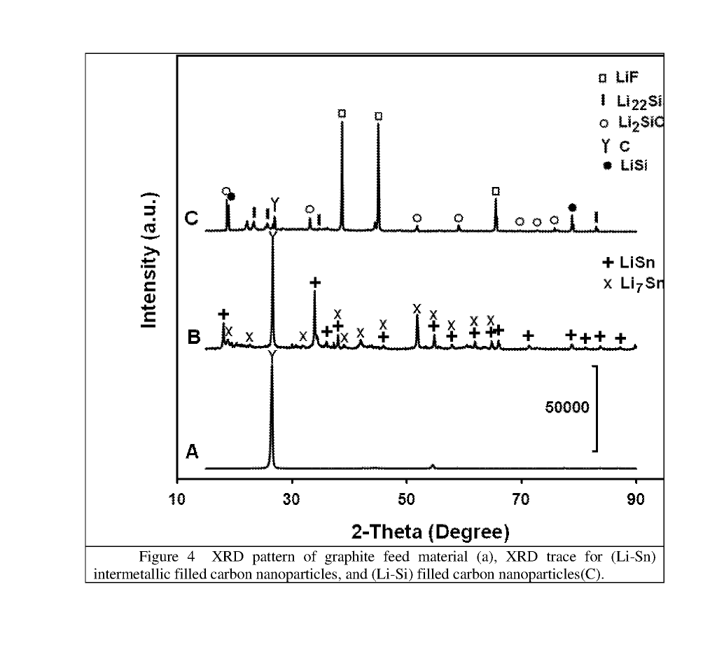

FIG. 3 shows electron micrographs illustrating powders comprising intermetallic cored nanotubes and nanoparticles according to aspects of the invention; and

FIG. 4 shows XRD patterns derived from a graphite feedstock material, a powder comprising lithium-tin filled nanoparticles and a powder comprising lithium-silicon filled nanoparticles.

As shown in FIG. 1, an anode for a rechargeable Li-ion cell embodying an aspect of the invention comprises a layer 2 of intermetallic metal-cored or metalloid-cored carbon nanostructures supported on a conductive metal substrate. The substrate is in the form of an aluminium sheet or film 4. The nanostructures are in the form of a powder and may be mixed with a binder and/or a plasticiser before being applied to the substrate, if required to secure the nanostructures to the substrate. The requirement to secure the nanostructures will depend on the type of electrolyte to be used in the cell, which may be a solid, or a liquid or a colloid such as a gel.

FIG. 2 shows a schematic cross section of a rechargeable Li-ion cell embodying an aspect of the invention. The cell comprises an anode 2, 4 as shown in FIG. 1, an electrolyte 6 positioned between the layer of nanostructures 2 of the anode, and a cathode 8,10. The cathode comprises a conductive cathode support 8 and a lithium insertion layer 10. The electrolyte and the lithium insertion layer may be as in a conventional lithium ion cell. For example the lithium insertion layer 10 may comprise LiₓCoO₂ (0.5<=x<=1) or LiFePO₄ supported on an aluminium cathode support 8, and the electrolyte 6 may comprise a lithium salt, such as LiPF₆, in an organic solvent such as ethylene carbonate, or a conventional polymer electrolyte allowing Li-ion migration. The cathode support is made from aluminium, but may be made from other suitable conductive metals, for example from copper.

Electrical contacts of the rechargeable cell are connected to the anode and cathode supports.

The powder comprising intermetallic-cored nanoscale carbon materials can be formed by an electrolytic technique in which an ion of a molten salt, such as lithium chloride, is intercalated into cathodically-polarised graphite. At sufficiently high levels of intercalation, the graphite disintegrates and forms various nanoscale carbon species that separate from the cathode and assemble in the molten salt. At least some of the carbon species form from portions of graphene sheets, which can wrap around metallic particles to form filled nanostructures. The carbon product can be retrieved from the molten salt through filtering and/or extraction.

The molten salt electrolytic method enables the formation of carbon nanoparticles that are filled, or cored, with intermetallic compounds. This is achieved by performing the electrolysis in the presence of small amounts of metal chloride, fluoride or oxide, dissolved in the salt to form easily reducible cations, such as Sn²⁺ or Si⁴⁺.

In an example, a graphite electrode and an inert anode (optionally also graphite) were contacted with, or immersed in, a molten LiCI electrolyte containing 2 wt % SnCl₂. A voltage source was coupled to the graphite and to the anode to apply a cathodic potential to the graphite. A molybdenum wire was immersed in the electrolyte to act as a reference electrode.

The electrode was a rod of EC4 commercial grade graphite (Tokai Carbon UK (RTM)), with an average grain size of 0.013 mm, a density of 1.75 g/cm³, and an outer diameter of 6.5 mm. A length of about 50 mm of the rod was immersed in the electrolyte.

About 142 to 200 g of the molten salt electrolyte was used. The reactor for containing the molten salt was initially flushed with argon gas, dried over calcium sulphate prior to use, at a rate of 100 cm³/minute. The temperature was set at 270° C. and held for at least 4 hours to dry the salt and to remove oxygen from the system. Thereafter the temperature was raised to the operating temperature of 800° C.

The electrolysis was conducted using a Powerstat Sycopel Scientific (RTM) power supply (Powerstat 10 V at 18 A).

After the electrolysis, the reactor was allowed to cool. The carbonaceous product was extracted from the salt by dissolving the contents of the reactor in methanol, followed by filtering through filter paper. Any solvent that dissolves alkali halides without reacting with methanol could be used instead of methanol. The filter paper containing the carbon product was treated by a Soxhlet extraction procedure for 48 hours to remove the salt from the nanoparticles.

The operating voltage was found to have a close relationship with the composition of the product. The optimum voltage for carbon nanoparticle production was −3.0 V versus the molybdenum electrode. However Carbon nanostructures can be obtained by applying a voltage of −2.0V to −6.0 V or more versus the molybdenum electrode.

The electrolytic technique can be used to produce intermetallic-cored or nanoparticles and nanotubes. The reaction conditions applied determine the ratio of nanoparticles to nanotubes that are formed, but it is desirable to use conditions as described above to produce a high yield of nanoparticles or a high ration of nanoparticles to nanotubes.

In an example, a graphite electrode and an inert anode (optionally also graphite) were contacted with, or immersed in, a molten LiCI electrolyte containing 1-5 wt % K₂SiF₆. A voltage source was coupled to the graphite and to the anode to apply a cathodic potential to the graphite. A molybdenum wire was immersed in the electrolyte to act as a reference electrode.

The electrode was a rod of MSG34 commercial grade graphite (Morgan), with an outer diameter of 15.0 mm. A length of about 60 mm of the rod was immersed in the electrolyte.

About 550 g of LiCI and 28 g K₂SiF₆ were used. The reactor for containing the molten salt was raised at 820° C.

The electrolysis in the galvanostatic mode at an anodic current density of 0.9-1.3 A cm⁻², corresponding a cathodic potential of −4 V to −5 V versus the molybdenum electrode was conducted using a suitable power supply.

After the electrolysis, the reactor was allowed to cool. The carbonaceous product was extracted from the salt by dissolving the contents of the reactor in methanol, followed by filtering through filter paper. The filter paper containing the carbon product was dried at 130° C. for 4 h.

FIG. 3 shows intermetallic -cored carbon nanostructures produced by the electrolysis methods described above.

FIG. 3a illustrates a portion of a powder comprising lithium-silicon intermetallic-cored nanoparticles 100 and nanotubes 110. The graphite walls 115 of the nanostructures 100,110 can be seen to have a thickness of about 10 nm. Silicon-lithium intermetallics 120 appear as a darker region on the micrographs and illustrate that the intermetallics are contained within the carbon nanostructures.

FIG. 3b illustrates a portion of a powder comprising lithium-tin intermetallic-cored nanoparticles 200 and nanotubes 210. The nanoparticles 200 have a diameter of between about 10 nm and 20 nm and are agglomerated in a mass having a diameter of several hundred nanometres. Lithium-silicon intermetallics 220 appear as a darker region on the micrographs and illustrate that the intermetallics are contained within the carbon is nanostructures.

FIG. 4 illustrates X-ray diffraction (XRD) patterns corresponding to the powders of FIGS. 3a and 3b. FIG. 4A is an XRD trace from a graphite feedstock used as an electrode in a method of forming the nanostructures.

FIG. 4B is an XRD trace from the powder illustrated in FIG. 3b. This trace shows peaks corresponding to various lithium-tin intermetallics.

FIG. 4C is an XRD trace from the powder illustrated in FIG. 3a. This trace shows peaks corresponding to various lithium-silicon intermetallics.

A lower applied voltage favours the production of nanotubes rather than nanoparticles. It should be noted that the nanoparticle diameter is advantageously much smaller than the nanotube diameter, and this can be seen clearly in FIG. 3b. As described above, it is preferable to use a nanoscale carbon product containing at least a large proportion of metal-cored carbon nanoparticles rather than nanotubes, for improved performance of the anode. The electrolytic method described above is capable of producing mixtures of nanoparticles and nanotubes, with the proportion of nanoparticles to nanotubes varying depending on the electrolysis conditions.

As described above, a binder may optionally be used to attach metal-cored or metalloid-cored nanoparticles to a substrate to form an anode. However, initial results suggest that the nanoparticles in powders formed by the electrolytic method tend to agglomerate, and therefore a binder may not be required to attach the nanoparticles to a substrate. This may advantageously increase the density of nanoparticles which can be attached to the substrate, and consequently the mass of lithium which can be inserted into the anode.

The proportion of nanoparticles to nanotubes may be controlled by varying process parameters such as applied voltage and temperature. A parameter that may influence the form of the nanostructures produced is the average out-of-plane crystallite size of the material used as the graphite electrode. This is illustrated by the following two examples.

Carbon nano-structures were produced using a method and apparatus substantially as described above. The graphite electrode was formed of a graphite material having an average out-of-plane crystallite size of 35 nm. The temperature of the salt at the start of electrolysis was 780° C., and this temperature increased to a maximum of 830° C. during electrolysis due to the exothermic reaction at the graphite electrode. The potential difference between the graphite electrode and a Mo reference electrode was −2.5 V. A powder of carbon nanostructures was recovered. On visual inspection, the powder consisted of 70 volume % carbon nano-tubes, 25 volume % carbon nanoparticles, and 5 volume % of micrometer-sized carbon components.

In a further example, carbon nano-structures were produced using a method and apparatus substantially as described above, using a graphite electrode formed of a graphite material having an average out-of-plane crystallite size of 15 nm. The temperature of the salt at the start of electrolysis was 780° C., and this temperature increased to a maximum of 810° C. during electrolysis. The potential difference between the graphite electrode and a Mo reference electrode was −2.0 V. A powder of carbon nanostructures was recovered. On visual inspection, the powder consisted of 95 volume % carbon nanoparticles, and 5 volume % of micrometer-sized carbon components. No carbon nanotubes were observed.

1. A powder comprising a plurality of carbon nanostructures, at least a portion of the carbon nanostructures defining an internal cavity containing metallic lithium, a lithium compound, or a lithium alloy.

2. The powder according to claim 1 in which carbon nanoparticles contain said metallic lithium, lithium compound, or lithium alloy.

3. The powder according to claim 1 comprising carbon nanotubes.

4. The powder according to claim 1 in which at least a portion of the carbon nanostructures are fabricated by a molten salt electrolysis process.

5. The powder according to claim 1 wherein a portion of carbon nanostructures are carbon nanotubes and/or carbon nanofibers.

6. The powder according to claim 5 in which the ratio of number of carbon nanostructures to number of other carbon nanostructures is greater than 1:1.

7. The powder according to claim 1 which the carbon nanostructures are powdered carbon nanoparticles not comprising carbon nanotubes.

8. The powder according to claim 1 in which each of the carbon nanostructures define an internal cavity containing the metallic lithium, lithium compound, or a lithium alloy and at least one other metal or metalloid comprising one or more graphene sheets wrapped around a portion of the metal or alloy.

9. The powder according to claim 1 in which the lithium alloy comprises an element selected from the group consisting of silicon, tin, zinc, strontium, lead, antimony, aluminium, and germanium.

10. The powder according to claim 8 in which the at least one other metal or metalloid is two or more elements selected from the group consisting of silicon, tin, zinc, strontium, lead, antimony, aluminium, and germanium.

11. The powder according to claim 1 used as a component part of an anode for a Li-ion rechargeable cell.

12. A method of forming a powder comprising a plurality of carbon nanostructures, at least a portion of the carbon nanostructures defining an internal cavity containing metallic lithium, comprising the steps of
arranging a graphite electrode in contact with a molten salt in an electrolysis cell, the molten salt comprising lithium;
applying a cathodic potential to the graphite electrode such that metallic lithium reacts at the graphite electrode and the graphite electrode disintegrates into a plurality of carbon nanostructures containing lithium;
collecting the nanostructures; and
removing salt from the nanostructures without removing lithium.

13. A method of forming a powder comprising a plurality of carbon nanostructures, at least a portion of the carbon nanostructures defining an internal cavity containing an alloy of lithium and at least one other metal or metalloid, comprising the steps of
arranging a graphite electrode in contact with a molten salt in an electrolysis cell, the molten salt comprising a lithium salt and a salt of the at least one other metal or metalloid;
applying a cathodic potential to the graphite electrode such that the at least one other metal or metalloid deposits at the graphite electrode and lithium reacts with the graphite electrode such that it disintegrates into a plurality of carbon nanostructures containing an alloy of lithium and at least one other metal or metalloid;
collecting the nanostructures; and
removing salt from the nanostructures without removing lithium.

14. The method according to claim 12 in which salt is removed by washing in a liquid that removes the salt without reacting with the lithium.

15. The method according to claim 14 in which salt is removed using methanol, hydrazine, or ethylene carbonate.

16. The method according to claim 12 further comprising a step of drying the nanostructures.

17. The method according to claim 12 in which the salt is removed by heating the nanostructures under a protective atmosphere or vacuum.

18. The method according to claim 12 wherein the carbon nanostructures comprise nanotubes and nanoparticles further comprising a step of controlling the proportion of nanotubes to nanoparticles formed by controlling the temperature of the salt and/or the potential applied to the graphite electrode.

19. The method according to claim 12 in which the molten salt comprises lithium chloride.

20. The method according to claim 13 in which the salt of the at least one other metal or metalloid is a chloride salt.

21. The method according to claims 13 in which the molten salt comprises a silicon fluoride salt, and the carbon nanostructures define a cavity containing a lithium silicon alloy.

22. The method according to claim 12 comprising the step of collecting the nanostructures after removing the salt and mixing the nanostructures with a portion of conductive nanoparticles.

23. The method according to claim 22 in which the portion of conductive nanoparticles does not contain lithium or a lithium alloy.

24. A method of forming a powder comprising a plurality of carbon nanostructures, at least a portion of the carbon nanostructures defining an internal cavity containing an alloy comprising lithium and silicon, comprising the steps of
arranging a graphite electrode in contact with a molten salt in an electrolysis cell, the molten salt comprising a lithium salt and a non-chloride silicon salt;
applying a cathodic potential to the graphite electrode such that silicon deposits at the graphite electrode and lithium reacts with the graphite electrode such that it disintegrates into a plurality of carbon nanostructures containing an alloy comprising lithium and silicon;
collecting the nanostructures; and
washing salt from the nanostructures.

25. The method according to claim 24 in which the molten salt is a silicon fluoride salt.

26. The method of forming an anode for a Li-ion cell according to claim 12 comprising the step of coupling the nanostructure to an electrical conductor.

27. The method of forming an anode according to claim 26 in which the conductor is an electrically conductive substrate, and the nanostructure is coupled as a layer on the surface of the electrically conductive substrate.

28. The method of forming an anode according to claim 26 in which the nanostructure is mixed with a binder prior to being coupled to the electrical conductor.

29. An anode for a Li-ion rechargeable cell comprising the product produced according to the method defined by claim 12, coupled to a conductor.

30. The anode according to claim 29 in which the product is coupled to a conductive substrate without the use of a binder.

31. The anode according to claim 29 in which the product is combined with a binder and coupled to a conductive substrate.

32. A Li-ion rechargeable cell comprising the product produced by the method defined by claim 13.

33. (canceled)
